(19) United States
(12) Patent Application Publication
(10) Pub. No.: US 2023/0140589 A1
(43) Pub. Date: May 4, 2023

(54) INKJET RECORDING DEVICE

(71) Applicant: KYOCERA Document Solutions Inc., Osaka (JP)

(72) Inventor: Hiroyuki UEDA, Osaka (JP)

(73) Assignee: KYOCERA Document Solutions Inc., Osaka (JP)

(21) Appl. No.: 17/977,784

(22) Filed: Oct. 31, 2022

(30) Foreign Application Priority Data
Nov. 4, 2021 (JP) 2021-180107

(51) Int. Cl. B41J 29/17; B41J 11/00

(52) U.S. Cl. CPC B41J 29/17; B41J 11/007

(57) ABSTRACT

An inkjet recording device includes a conveying unit that conveys a paper sheet by use of an endless conveyor belt, a recording unit that includes a recording head disposed to face a carrying surface of the conveyor belt so as to eject ink through ink ejection nozzles of the recording head to the paper shed being conveyed by the conveyor belt, a sucking roller that, on an upstream side of the recording unit in a sheet conveying direction, makes contact with the paper sheet being conveyed and rotates in that state, and a sucking device. The sucking roller is columnar in outer shape and has many air sucking holes formed in a side surface thereof so that air in a vicinity of the sucking roller is sucked through the air sucking holes by the sucking device.

### INCORPORATION BY REFERENCE

This application is based upon and claims the benefit of priority from the corresponding Japanese Patent Application No. 2021-180107 filed on Nov. 4, 2021, the entire contents of which are hereby incorporated by reference.

### BACKGROUND

The present disclosure relates to an inkjet recording device that ejects ink through ink ejection nozzles of a recording head so as to perform recording.

As a recording device such as a facsimile machine, a copier, or a printer, an inkjet recording device is widely used, which ejects ink through the nozzles of the recording head to form an image, so that a high definition image can be formed.

Such an inkjet recording device has a problem that paper dust generated from a paper sheet as a recording medium might clog the nozzle and cause a nozzle ejection failure (missing dot), resulting in lowering of image quality.

### SUMMARY

An inkjet recording device according to an aspect of the present disclosure includes a conveying unit, a recording unit, a sucking roller, and a sucking device. The conveying unit conveys a paper sheet by use of an endless conveyor belt. The recording unit includes a recording head disposed to face a carrying surface of the conveyor belt so as to eject ink through ink ejection nozzles of the recording head to the paper sheet being conveyed by the conveyor belt. On an upstream side of the recording unit in a sheet conveying direction, the sucking roller makes contact with the paper sheet being conveyed and rotates in that state. The sucking device is joined to the sucking roller. The sucking roller is columnar in outer shape and has many air sucking holes formed in a side surface thereof so that air in a vicinity of the sucking roller is sucked through the air sucking holes by the sucking device.

### BRIEF DESCRIPTION OF THE DRAWINGS

FIG. 1 is a sectional side view illustrating a schematic structure of a printer according to an embodiment of the present disclosure.

FIG. 2 is a sectional side view illustrating a structure of a first belt conveying unit, a recording unit, a second belt conveying unit, and their vicinity of the printer according to this embodiment.

FIG. 3 is a plan view from above of the first belt conveying unit and the recording unit of the printer according to this embodiment.

FIG. 4 is a block diagram illustrating an example of a control path of the printer according to this embodiment.

FIG. 5 is a perspective view illustrating an example of a sucking roller used in the printer according to this embodiment.

FIG. 6 is a cross-sectional view of a roller main body of the sucking roller shown in FIG. 5 as cut in a direction orthogonal to an axial direction thereof.

FIG. 7 is a sectional side view illustrating a flow path of an airflow, which includes the sucking roller and a sucking device used in the printer according to this embodiment.

FIG. 8 is a perspective view illustrating a modification example of the sucking roller used in the printer according to this embodiment.

FIG. 9 is a cross-sectional view of a roller main body of the sucking roller shown in FIG. 8 as cut in a direction orthogonal to an axial direction thereof.

FIG. 10 is a perspective view illustrating another modification example of the sucking roller used in the printer according to this embodiment.

FIG. 11 is a cross-sectional view of a roller main body of the sucking roller shown in FIG. 10 as cut in a direction orthogonal to an axial direction thereof.

FIG. 12 is a perspective view illustrating still another modification example of the sucking roller used in the printer according to this embodiment.

FIG. 13 is a cross-sectional view of a roller main body of the sucking roller shown in FIG. 12 as cut in a direction orthogonal to an axial direction thereof.

### DETAILED DESCRIPTION

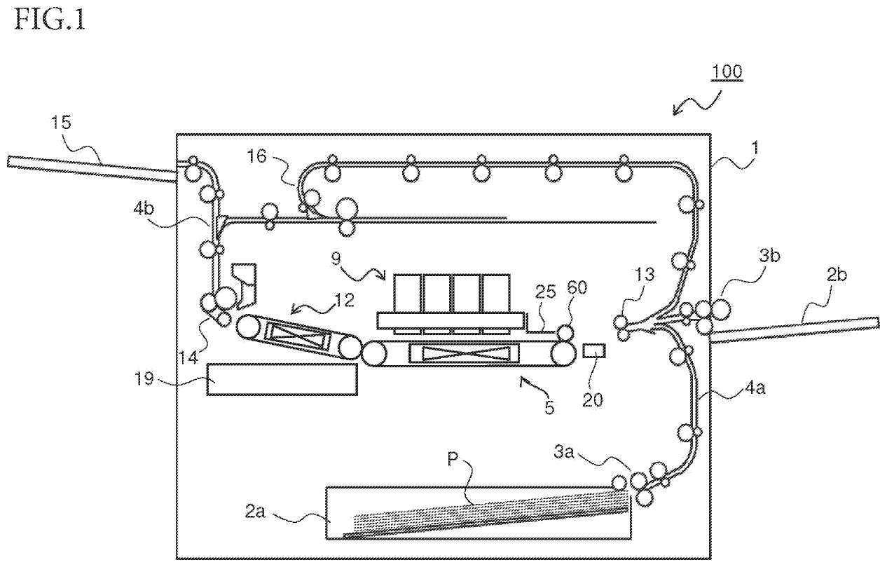

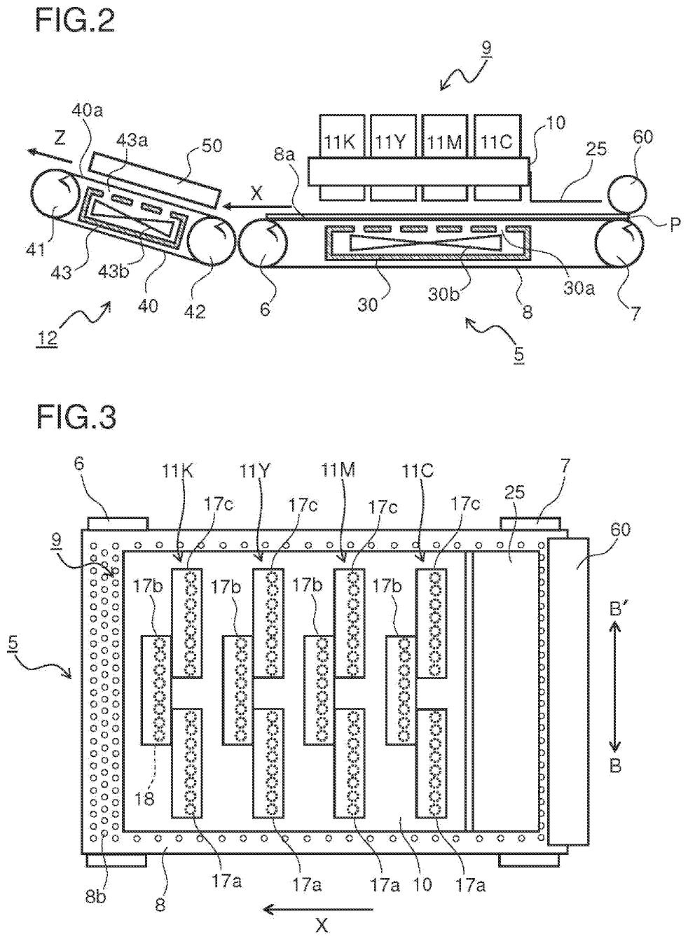

Hereinafter, an embodiment of the present disclosure is described with reference to the drawings. FIG. 1 is a view illustrating a schematic configuration of a printer 100 of an inkjet recording method according to an embodiment of the present disclosure. FIG. 2 is a sectional view illustrating a structure of a first belt conveying unit 5, a recording unit 9, a second belt conveying unit 12, and their vicinity of the printer 100 illustrated in FIG. 1. FIG. 3 is a plan view from above of the first belt conveying unit 5 and the recording unit 9 of the printer 100 illustrated in FIG. 1.

As illustrated in FIG. 1, the printer 100 includes a sheet feed cassette 2a as a sheet housing unit disposed on the lower side in a printer main body 1, and a manual sheet feeding tray 2b is provided outside a right side surface of the printer main body 1. A sheet feeding device 3a is disposed downstream of the sheet feed cassette 2a in a sheet conveying direction, i.e. on the upper right side of the sheet feed cassette 2a in FIG. 1. In addition, a sheet feeding device 3b is disposed downstream of the manual sheet feeding tray 2b in the sheet conveying direction. i.e. on the left side of the manual sheet feeding tray 2b in FIG. 1. The sheet feeding devices 3a and 3b enable to separate and feed paper sheets (sheets) P one by one.

In addition, a first sheet conveying path 4a is provided inside the printer 100. The first sheet conveying path 4a is positioned on the upper right side of the sheet feed cassette 2a, i.e. on the left side of the manual sheet feeding tray 2b. The paper sheet P sent out from the sheet feed cassette 2a passes through the first sheet conveying path 4a and is conveyed vertically upward along the side surface of the printer main body 1. The paper sheet sent out from the manual sheet feeding tray 2b passes through the first sheet conveying path 4a and is conveyed substantially horizontally to the left.

A registration roller pair 13 is provided at a downstream end of the first sheet conveying path 4a in the sheet conveying direction. Further, the first belt conveying unit (conveying unit) 5 and the recording unit 9 are disposed near the registration roller pair 13 on the downstream side. The registration roller pair 13 corrects a skew of the paper sheet P, and sends out the paper sheet P to the first belt conveying unit 5 in synchronization with an ink ejection operation by the recording unit 9.

In addition, between the registration roller pair 13 and the first belt conveying unit 5, there is disposed a contact image sensor (CIS) 20 as a sheet detection sensor for detecting an end position of the paper sheet P in its width direction (in a direction perpendicular to the sheet conveying direction).

The first belt conveying unit 5 includes an endless first conveyor belt 8 (see FIG. 2) stretched around a first drive roller 6 and a first driven roller 7. The paper sheet P sent out from the registration roller pair 13 passes below the recording unit 9, in the state where it is sucked and held on a carrying surface 8a of the first conveyor belt 8.

A sucking roller 60 is disposed upstream of the recording unit 9 in the sheet conveying direction and at a position facing an upstream end of the first conveyor belt 8. The sucking roller 60 makes contact with the carrying surface 8a of the first conveyor belt 8 or the paper sheet P placed on the carrying surface 8a so as to be conveyed, and rotates in that state following rotation of the first conveyor belt 8. A detailed configuration of the sucking roller 60 will be described later.

A plate-shaped member 25 is disposed between the recording unit 9 and the sucking roller 60. The plate-shaped member 25 is secured to a head housing 10 holding line heads 11C, 11M, 11Y, and 11K and is disposed substantially parallel to the carrying surface 8a of the first conveyor belt 8 at a predetermined gap therefrom. The plate-shaped member 25 faces the first conveyor belt 8 over an entire area in a width direction thereof (a direction perpendicular to a plane on which FIG. 2 is drawn), and a space is formed between a lower surface of the plate-shaped member 25 and the carrying surface 8a.

A first sheet sucking unit 30 is provided at a location facing a backside of the carrying surface 8a of the first conveyor belt 8, inside the loop of the first conveyor belt 8. The first sheet sucking unit 30 has many holes 30a formed in an upper surface thereof for sucking air, and inside the first sheet sucking unit 30, there is provided a first fan 30b that can suck air downward through the upper surface. In addition, the first conveyor belt 8 also has many air holes 8b for sucking air (see FIG. 3). With the configuration described above, the first belt conveying unit 5 conveys the paper sheet P while sucking and holding the same on the carrying surface 8a of the first conveyor belt 8.

The recording unit 9 includes the line heads 11C, 11M, 11Y, and 11K that perform recording of an image on the paper sheet P being conveyed while sucked and held on the carrying surface 8a of the first conveyor belt 8. Inks in the line heads 11C to 11K are sequentially ejected therefrom to the paper sheet P sucked on the first conveyor belt 8 so as to correspond to information of image data received from an external computer or the like. With this configuration, four color inks of cyan, magenta, yellow, and black are superimposed so that a full-color image is recorded on the paper sheet P. The printer 100 can also record a monochrome image.

As illustrated in FIG. 3, the recording unit 9 includes the head housing 10 and the line heads 11C, 11M, 11Y, and 11K held by the head housing 10. Each of the line heads 11C to 11K has a recording area of a width not smaller than that of the paper sheet P conveyed thereto. Each of the line heads 11C to 11K is supported at a height to form a predetermined gap (for example, 1 mm) between itself and the carrying surface 8a of the first conveyor belt 8 and includes three recording heads 17a to 17c arranged in a zigzag manner along a sheet width direction (a B-B′ direction) orthogonal to the sheet conveying direction. Many ink ejection nozzles 18 are arranged in an ink ejection surface of each of the recording heads 17a to 17c.

The recording heads 17a to 17c constituting each of the line heads 11C to 11K are supplied with ink of the corresponding color among the four color inks (cyan, magenta, yellow, and black color inks), which are respectively stored in ink tanks (not shown).

Each of the recording heads 17a to 17c can eject ink through the ink ejection nozzles 18 corresponding to print positions in accordance with image data received from an external computer or the like, to the paper sheet P being conveyed while sucked and held on the carrying surface 8a of the first conveyor belt 8. With this configuration, the cyan, magenta, yellow, and black color inks are superimposed so that a color image is formed on the paper sheet P on the first conveyor belt 8.

On the downstream side (the left side in FIG. 1) of the first belt conveying unit 5 in the sheet conveying direction, there is disposed the second belt conveying unit 12. The paper sheet P with the image recorded in the recording unit 9 is sent to the second belt conveying unit 12, and passes through the second belt conveying unit 12 while the inks on a surface of the paper sheet P are dried.

The second belt conveying unit 12 includes an endless second conveyor belt 40 stretched around a second drive roller 41 and a second driven roller 42. The second conveyor belt 40 is driven by the second drive roller 41 to turn in a counterclockwise direction in FIG. 2. The paper sheet P with the image recorded in the recording unit 9 is conveyed by the first belt conveying unit 5 in an arrow X direction, transferred to the second conveyor belt 40, and is conveyed in an arrow Z direction in FIG. 2.

A second sheet sucking unit 43 is provided at a location facing a backside of a carrying surface 40a of the second conveyor belt 40, inside the loop of the second conveyor belt 40. The second sheet sucking unit 43 has many holes 43a formed in an upper surface thereof for sucking air, and inside the second sheet sucking unit 43, there is provided a second fan 43b that can suck air downward through the upper surface. In addition, the second conveyor belt 40 also has many air holes for sucking air (not shown). With the configuration described above, the second belt conveying unit 12 conveys the paper sheet P while sucking and holding the same on the carrying surface 40a of the second conveyor belt 40.

In addition, a conveyance guide part 50 is provided at a position facing the carrying surface 40a of the second conveyor belt 40. The conveyance guide part 50 constitutes a sheet conveyance path together with the carrying surface 40a of the second conveyor belt 40 and suppresses warping or fluttering of the paper sheet P sucked and held on the carrying surface 40a by the second sheet sucking unit 43.

A decurler unit 14 is provided downstream of the second belt conveying unit 12 in the sheet conveying direction and in a vicinity of a left side surface of the printer main body 1. The paper sheet P after the inks are dried in the second belt conveying unit 12 is conveyed to the decurler unit 14, which corrects a curl of the paper sheet P.

On the downstream side (the upper side in FIG. 1) of the decurler unit 14 in the sheet conveying direction, there is provided a second sheet conveying path 4b. When double-sided recording is not performed, the paper sheet P after passing through the decurler unit 14 is discharged onto a sheet discharge tray 15 provided outside a left side surface of the printer 100, from the second sheet conveying path 4b via a discharge roller pair. When the double-sided recording is performed on the paper sheet P, the paper sheet P, after recording on one side and passing through the second belt conveying unit 12 and the decurler unit 14, passes through the second sheet conveying path 4b and is conveyed to a reverse conveying path 16. The paper sheet P sent to the reverse conveying path 16 is changed in the conveying direction so as to be upside down, passes through an upper part of the printer 100, and is conveyed to the registration roller pair 13. After that, the paper sheet P is conveyed to the first belt conveying unit 5 again, in the state where the side with no image recorded faces upward.

In addition, a maintenance unit 19 is disposed below the second belt conveying unit 12. When performing maintenance of the recording heads 17, the maintenance unit 19 moves to below the recording unit 9, wipes ink pushed out (purged) from the ink ejection nozzles 18 (see FIG. 3) of the recording heads 17, and collects the wiped ink.

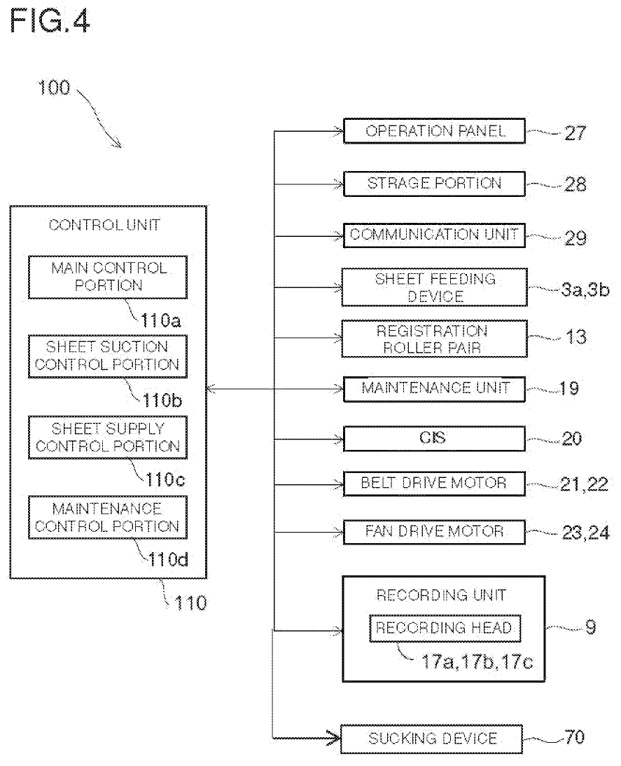

FIG. 4 is a block diagram illustrating an example of a control path of the printer 100 according to this embodiment. The printer 100 further includes, in addition to the configuration described above, belt drive motors 21 and 22, fan drive motors 23 and 24, an operation panel 27, a storage unit 28, a communication unit 29, and a sucking device 70.

The belt drive motors 21 and 22 respectively drive the first drive roller 6 and the second drive roller 41 to rotate, so that the first conveyor belt 8 and the second conveyor belt 40 can turn. The fan drive motors 23 and 24 respectively drive the first fan 30b of the first sheet sucking unit 30 and the second fan 43b of the second sheet sucking unit 43 to rotate.

The operation panel 27 is an operation unit for receiving various setting inputs. For instance, by operating the operation panel 27, a user can input a size of the paper sheets P set in the sheet feed cassette 2a or on the manual sheet feeding tray 2b, i.e. information of a size of the paper sheet P that is conveyed by the first conveyor belt 8. In addition, by operating the operation panel 27, the user can also input the number of the paper sheets P to be printed or instruct a start of a print job. In addition, the operation panel 27 also has a function as a notification device for notifying about an operating state of the printer 100.

The storage unit 28 is a memory for storing an operation program of a control unit 110 and various sets of information, and it includes a read only memory (ROM), a random access memory (RAM), a nonvolatile memory, and the like. The information set by the operation panel 27 is stored in the storage unit 28.

The communication unit 29 is a communication interface for communicating information with an external device (such as a personal computer (PC)). For instance, when the user operates the PC and sends a print command with image data to the printer 100, the image data and the print command are input to the printer 100 via the communication unit 29. In the printer 100, a main control portion 110a controls the recording heads 17a to 17c to eject ink on the basis of the image data, so that an image can be recorded on the paper sheet P.

The sucking device 70 is joined to the sucking roller 60 and sucks paper dust of the paper sheet P to be conveyed to the recording unit 9 via the sucking roller 60.

In addition, the printer 100 according to this embodiment includes the control unit 110. The control unit 110 is constituted of a central processing unit (CPU) and a memory, for example. Specifically, the control unit 110 includes the main control portion 110a, a sheet suction control portion 110b, a sheet supply control portion 110c, and a maintenance control portion 110d.

The main control portion 110a controls operations of individual units in the printer 100. For instance, drive of each roller in the printer 100, ink ejection from the recording heads 17a to 17c when recording an image, and the like are controlled by the main control portion 110a. The main control portion 110a also drives the sucking device 70 to remove paper dust of the paper sheet P to be conveyed to the recording unit 9.

The sheet suction control portion 110b sends a control signal to the fan drive motors 23 and 24 so as to control rotations of the first fan 30b and the second fan 43b, and thus a state of the paper sheet P sucked and held on the first conveyor belt 8 or the second conveyor belt 40 can be controlled.

The sheet supply control portion 110c is a recording medium supply control portion that controls the registration roller pair 13 as a recording medium supply unit. For instance, the sheet supply control portion 110c controls the registration roller pair 13 based on a detection timing of a rear end of the paper sheet P by the CIS 20, and thus controls a conveyance timing of the following paper sheet P.

The maintenance control portion 110d controls the recording heads 17a to 17c to perform the purge operation described above in which the ink ejection nozzles 18 push out ink in a forced manner. When the maintenance control portion 110d controls the recording heads 17a to 17c to perform the purge operation, it also controls drive of the maintenance unit 19 described above (e.g. movement to below the recording unit 9 and retraction).

Note that the control unit 110 may further include a calculation portion that performs necessary calculation and a time measuring portion that measures time. In addition, the main control portion 110a may also works as the calculation portion or the time measuring portion described above.

As described above, there is the problem that paper dust generated from the paper sheet P might clog the ink ejection nozzles 18 of the recording heads 17 and cause an ink ejection failure (missing dot) of the ink ejection nozzles 18, resulting in lowering of image quality. Therefore, the printer 100 according to this embodiment uses the sucking roller 60 and the sucking device 70 to suck paper dust of the paper sheet P to be conveyed to the recording unit 9.

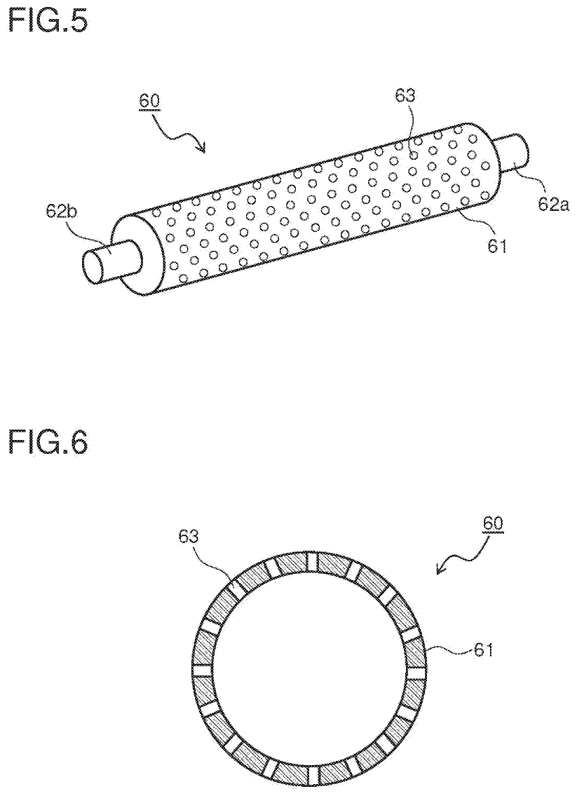

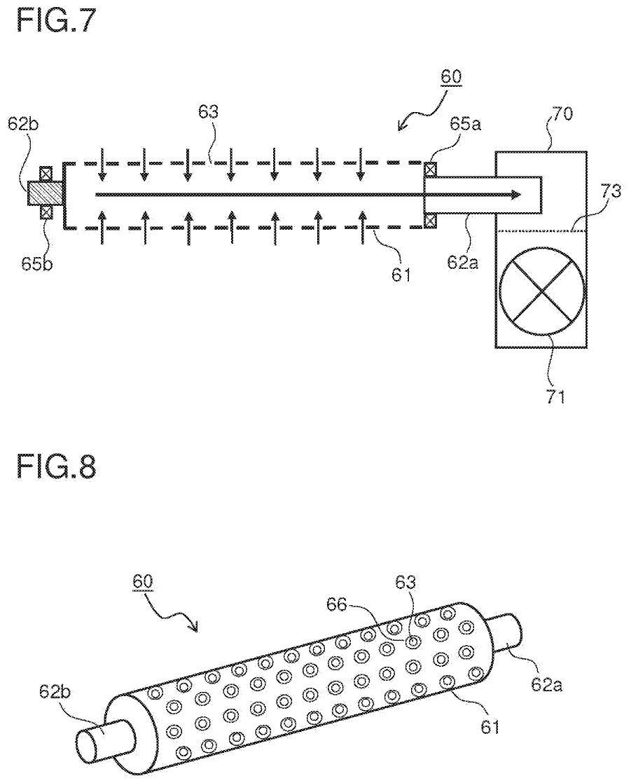

FIG. 5 is a perspective view illustrating an example of the sucking roller 60 used in the printer 100 according to this embodiment. FIG. 6 is a cross-sectional view of a roller main body 61 of the sucking roller 60 shown in FIG. 5 as cut in a direction (a radial direction) orthogonal to an axial direction thereof. FIG. 7 is a sectional side view illustrating a flow path of an airflow, which includes the sucking roller 60 and the sucking device 70, and is also a sectional view of the sucking roller 60 as cut along an axial direction thereof. A left side in FIG. 7 corresponds to a front side of the printer 100, and a right side therein corresponds to a rear side of the printer 100.

The sucking roller 60 has a columnar shape and includes the roller main body 61 of a cylindrical shape and a first rotary shaft 62a and a second rotary shaft 62b that are provided respectively at both ends of the roller main body 61 in the axial direction. The roller main body 61 is hollow and has many air sucking holes 63 formed in an outer circumferential surface (a columnar side surface) thereof. The air sucking holes 63 have a diameter of approximately 1 to 2 mm.

The first rotary shaft 62a has a hollow cylindrical shape with both ends thereof open and is secured on the rear side in the printer 100. That is, the first rotary shaft 62a is provided at one end of the roller main body 61 in the axial direction. One end of the first rotary shaft 62a is inserted into the one end of the roller main body 61 in the axial direction. A first bearing 65a is secured to the one end of the roller main body 61 in the axial direction so that the one end of the roller main body 61 in the axial direction is supported so as to be rotatable about the first rotary shaft 62a as a support axis. That is, one end of the sucking roller 60 (on the rear side) is supported so as to be rotatable by frictional motion between the first rotary shaft 62a and the first bearing 65a. The sucking device 70 is joined to the roller main body 61 via the first rotary shaft 62a. Specifically, the other end of the first rotary shaft 62a is connected to the sucking device 70.

The second rotary shaft 62b is secured to an end (the other end) of the roller main body 61 in the axial direction on the opposite side to the first rotary shaft 62a and is rotatably supported by a second bearing 65b that is secured on the front side in the printer 100. That is, the other end of the sucking roller 60 (on the front side) is supported so as to be rotatable by frictional motion between the second rotary shaft 62b and the second bearing 65b.

The sucking device 70 includes a sucking fan 71 and a filter 73. As shown by arrows in FIG. 7, the sucking fan 71 sucks air in a vicinity of the sucking roller 60 into the sucking device 70 via the air sucking holes 63 and the first rotary shaft 62a. The filter 73 is disposed upstream of the sucking fan 71 with respect to a flow path of an airflow and collects paper dust sucked together with the air into the sucking device 70. The air sucked by the sucking fan 71 is discharged to the outside of the printer 100 via an exhaust duct (not shown). The filter 73 may be disposed downstream of the sucking fan 71 with respect to a flow path of an airflow.

At a time of image recording on the paper sheet P, the main control portion 110a transmits a control signal to the sucking device 70 so as to drive the sucking fan 71 to rotate. With this configuration, before the paper sheet P fed from the sheet feed cassette 2a or the manual sheet feeding tray 2b is conveyed to the recording unit 9, paper dust adhering to the paper sheet P is sucked together with air through the air sucking holes 63 into the sucking roller 60 rotating in contact with the paper sheet P. The paper dust sucked into the sucking roller 60 passes through the first rotary shaft 62a and then is collected by the sucking filter 73 in the sucking device 70. Accordingly, it is possible to reduce paper dust adhering to the paper sheet P to be conveyed to the recording unit 9 and thus to suppress clogging of the ink ejection nozzles 18 caused by paper dust.

In addition, between the sucking roller 60 and the recording unit 9, the plate-shaped member 25 (see FIG. 2) is disposed to face the carrying surface 8a of the first conveyor belt 8, and air that has passed through a space between the plate-shaped member 25 and the carrying surface 8a is sucked into the sucking roller 60. That is, air flows to the sucking roller 60 along a surface of the paper sheet P sucked and held on the carrying surface 8a, and thus paper dust adhering to the paper sheet P can be efficiently sucked and removed. Here, a gap between the plate-shaped member 25 and the carrying surface 8a is set to a value not more than a preset threshold value, and thus it is possible to increase a velocity of an airflow between the plate-shaped member 25 and the carrying surface 8a and thus to enhance paper dust sucking efficiency.

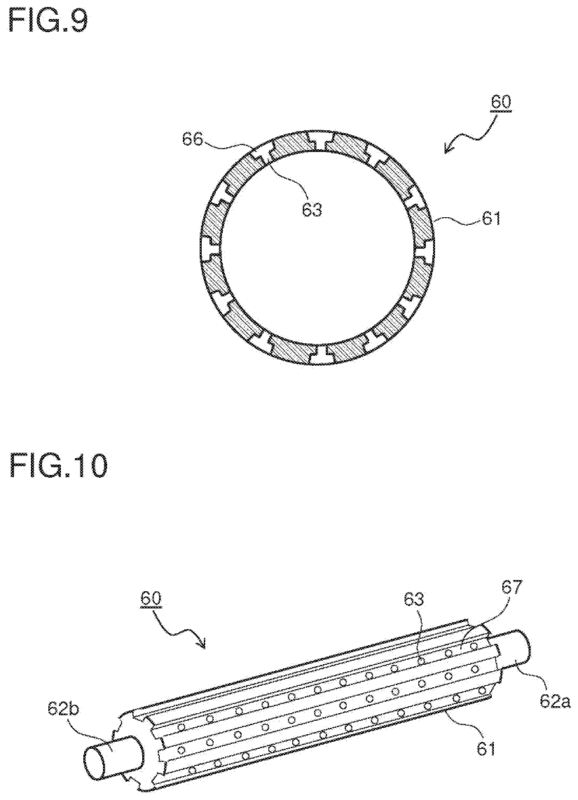

FIG. 8 is a perspective view illustrating a modification example of the sucking roller 60 used in the printer 100. FIG. 9 is a cross-sectional view of a roller main body 61 of the sucking roller 60 shown in FIG. 8 as cut in a direction (a radial direction) orthogonal to an axial direction thereof. In the modification example shown in FIG. 8 and FIG. 9, many concaves 66 are formed in a surface of the roller main body 61 of the sucking roller 60. The concaves 66 have a circular shape and are formed at substantially regular intervals in a circumferential direction and an axial direction of the roller main body 61. The concaves 66 have a diameter of approximately 4 to 5 mm and a depth of approximately 1 mm. Further, air sucking holes 63 are formed in bottom surfaces of the concaves 66, respectively. As for other parts of the sucking roller 60 and the sucking device 70, configurations thereof are similar to those shown in FIG. 5 to FIG. 7.

When air is sucked through the air sucking holes 63 into the sucking roller 60 at a time of image recording on the paper sheet P, the paper sheet P passing through the sucking roller 60 might be wrapped around the sucking roller 60 under a negative pressure, causing a paper jam.

To avoid the above situation, as shown in FIG. 8 and FIG. 9, the concaves 66 are provided in an outer circumferential surface of the roller main body 61, and the air sucking holes 63 are formed in the bottom surfaces of the concaves 66, respectively, so that a gap is formed between the paper sheet P being in contact with an outer circumferential surface of the sucking roller 60 and each of the air sucking holes 63. As a result, a sucking force of the sucking roller 60 with respect to the paper sheet P is reduced, and thus it is possible to suppress a phenomenon in which the paper sheet P is wrapped around the sucking roller 60.

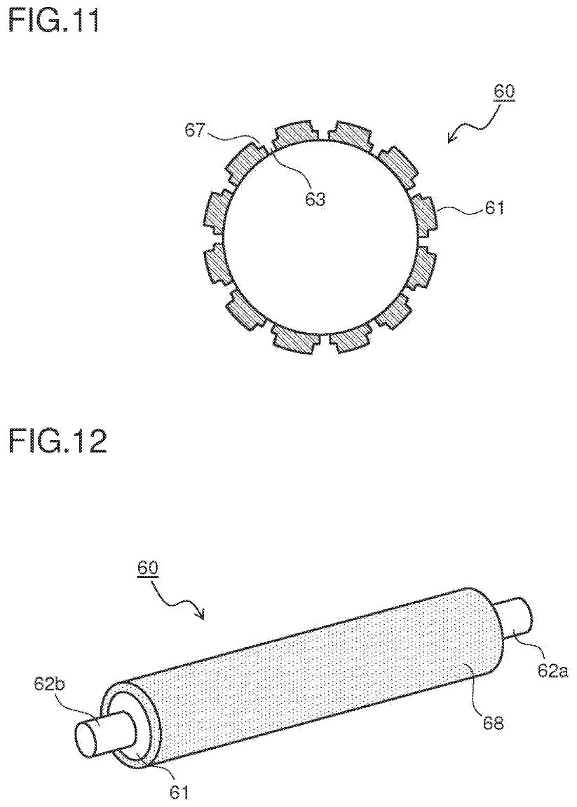

FIG. 10 is a perspective view illustrating another modification example of the sucking roller 60 used in the printer 100. FIG. 11 is a cross-sectional view of a roller main body 61 of the sucking roller 60 shown in FIG. 10 as cut in a direction (a radial direction) orthogonal to an axial direction thereof. In the modification example shown in FIG. 10 and FIG. 11, a plurality of grooves 67 is formed in a surface of the roller main body 61 of the sucking roller 60 so as to extend along the axial direction. The grooves 67 are formed at substantially regular intervals in a circumferential direction of the roller main body 61 and extend up to both ends of the roller main body 61 in the axial direction. The grooves 67 have a groove width of approximately 4 to 5 mm and a depth of approximately 1 mm. Further, a plurality of air sucking holes 63 is formed at constant intervals in a bottom surface of each of the grooves 67. As for other parts of the sucking roller 60 and the sucking device 70, configurations thereof are similar to those shown in FIG. 5 to FIG. 7.

According to a configuration shown in FIG. 10 and FIG. 11, by the grooves 67, a gap is formed between the paper sheet P being in contact with an outer circumferential surface of the sucking roller 60 and the air sucking holes 63. In addition, even in a state where the paper sheet P is in contact with the outer circumferential surface of the sucking roller 60, air flows into the air sucking holes 63 from both ends of the grooves 67, and thus there occurs a loss in negative pressure exerted in such a direction as to suck the paper sheet P. As a result, a sucking force of the sucking roller 60 with respect to the paper sheet P is reduced, and thus it is possible to suppress the phenomenon in which the paper sheet P is wrapped around the sucking roller 60.

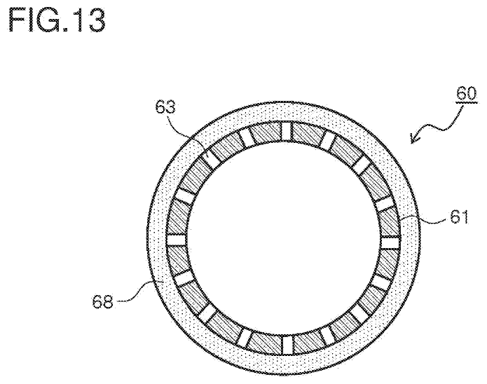

FIG. 12 is a perspective view illustrating still another modification example of the sucking roller 60 used in the printer 100. FIG. 13 is a cross-sectional view of a roller main body 61 of the sucking roller 60 shown in FIG. 12 as cut in a direction (a radial direction) orthogonal to an axial direction thereof. In the modification example shown in FIG. 12 and FIG. 13, the roller main body 61 is hollow and has many air sucking holes 63 formed in an outer circumferential surface thereof. Further, an elastic layer 68 having an open-cell structure is stacked on the outer circumferential surface of the roller main body 61. The elastic layer 68 has a thickness of 3 to 5 mm and is made of, for example, polyethylene or polyurethane sponge. As for other parts of the sucking roller 60 and the sucking device 70, configurations thereof are similar to those shown in FIG. 5 to FIG. 7.

According to a configuration shown in FIG. 12 and FIG. 13, by the elastic layer 68, a gap is formed between the paper sheet P being in contact with an outer circumferential surface of the sucking roller 60 and the air sucking holes 63. In addition, since the elastic layer 68 has the open-cell structure, even in the state where the paper sheet P is in contact with the outer circumferential surface of the sucking roller 60, air passes through the elastic layer 68 and flows into the air sucking holes 63. With this configuration, there occurs a loss in negative pressure exerted in such a direction as to suck the paper sheet P. As a result, a sucking force of the sucking roller 60 with respect to the paper sheet P is reduced, and thus it is possible to suppress the phenomenon in which the paper sheet P is wrapped around the sucking roller 60.

In a case where the sucking roller 60 shown in FIG. 12 and FIG. 13 is used for a long period of time, paper dust might be deposited on a surface of the elastic layer 68, causing deterioration in sucking performance. To avoid this, there may be provided a cleaning mechanism that removes paper dust on the surface of the elastic layer 68. As the cleaning mechanism, for example, a cleaning brush, a cleaning roller, a scraper, or the like can be used.

Other than the above, without being limited to the embodiment described above, the present disclosure can be variously modified within a scope not departing from the spirit thereof. For example, while the above embodiment describes a case where the paper sheet P is conveyed in a state of being sucked by negative-pressure suction on the first conveyor belt 8 and the second conveyor belt 40, the first conveyor belt 8 and the second conveyor belt 40 may be charged so that the paper sheet P is conveyed in a state of being sucked by electrostatic suction on the first conveyor belt 8 and the second conveyor belt 40 (an electrostatic suction method).

In addition, the above embodiment describes the line head type printer 100 as the inkjet recording device, which performs recording with the line heads 11C to 11K, each of which includes the recording heads 17a to 17e having the many ink ejection nozzles 18 arranged in the sheet width direction, but the present disclosure can be similarly applied to a serial type inkjet recording device that performs recording with a recording head 17 that moves over a sheet.

The present disclosure can be used for inkjet recording devices that perform recording by ejecting ink through the ink ejection nozzles of the recording head. Using the present disclosure, it is possible to provide the inkjet recording device that can effectively remove paper dust generated from a paper sheet, with a simple configuration.

What is claimed is:

1. An inkjet recording device, comprising:
a conveying unit that conveys a paper sheet by use of an endless conveyor belt;
a recording unit that includes a recording head disposed to face a carrying surface of the conveyor belt so as to eject ink through ink ejection nozzles of the recording head to the paper sheet being conveyed by the conveyor belt;
a sucking roller that, on an upstream side of the recording unit in a sheet conveying direction, makes contact with the paper sheet being conveyed and rotates in that state;
a sucking device that is joined to the sucking roller; and
a device main body that houses the conveying unit, the recording unit, the sucking roller, and the sucking device,
wherein
the sucking roller is columnar in outer shape and has many air sucking holes formed in a side surface thereof so that air in a vicinity of the sucking roller is sucked through the air sucking holes by the sucking device.

2. The inkjet recording device according to claim 1, wherein
the sucking roller includes:
a roller main body that is in a hollow cylindrical shape and has the many air sucking holes formed therein; and
a first rotary shaft that is in a hollow cylindrical shape and is provided at one end of the roller main body in an axial direction thereof, and
the sucking device is joined to the roller main body via the first rotary shaft.

3. The inkjet recording device according to claim 2, wherein
a first bearing is secured to the one end of the roller main body in the axial direction, and one end of the sucking roller in the axial direction is supported so as to be rotatable by frictional motion between the first rotary shaft secured to the device main body and the first bearing.

4. The inkjet recording device according to claim 2, wherein
the sucking roller includes a second rotary shaft that is secured to another end of the roller main body in the axial direction, and
another end of the sucking roller in the axial direction is supported so as to be rotatable by frictional motion between a second bearing secured to the device main body and the second rotary shaft.

5. The inkjet recording device according to claim 1, wherein
between the recording unit and the sucking roller, a plate-shaped member is disposed at a predetermined gap from the carrying surface, and air that has passed through a space between the plate-shaped member and the carrying surface is sucked into the sucking roller.

6. The inkjet recording device according to claim 1, further comprising:
a control unit that controls the conveying unit, the recording unit, and the sucking device,
wherein, at a time of image recording on the paper sheet, the control unit drives the sucking device to remove paper dust adhering to the paper sheet.

7. The inkjet recording device according to claim 1, wherein
the sucking device includes:
a sucking fan; and
a filter that collects paper dust sucked together with air into the sucking device by the sucking fan.

8. The inkjet recording device according to claim 1, wherein
many concaves are formed in a side surface of the sucking roller, and the air sucking holes are formed in bottom surfaces of the concaves, respectively.

9. The inkjet recording device according to claim 1, wherein
a plurality of grooves is formed in a side surface of the sucking roller so as to extend up to both ends of the sucking roller along an axial direction thereof, and the air sucking holes are formed in a bottom surface of each of the grooves.

10. The inkjet recording device according to claim 1, wherein
an elastic layer having an open-cell structure is stacked on a side surface of the sucking roller.

11. The inkjet recording device according to claim 10, further comprising:
a cleaning mechanism that removes paper dust on a surface of the elastic layer.

12. The inkjet recording device according to claim 1, wherein
the recording unit is of a line head type in which the recording head comprises a plurality of recording heads, and the plurality of recording heads is disposed along the sheet conveying direction for each of a plurality of colors.
